(19) United States
(12) Patent Application Publication
(10) Pub. No.: US 2009/0169683 A1
(43) Pub. Date: Jul. 2, 2009

(54) NUTRACEUTICAL FRACTIONS FROM CEREAL GRAINS

(76) Inventor: Christopher James Findlay, Guelph (CA)

Correspondence Address: Woods Oviatt Gilman LLP, 700 Crossroads Bldg, 2 State St., Rochester, NY, 14614, US

(21) Appl. No.: 11/910,914

(22) PCT Filed: Apr. 7, 2006
(86) PCT No.: PCT/CA2006/000509

§ 371 Date: May 21, 2008

(30) Foreign Application Priority Data
Apr. 8, 2005 (CA) 2,504,093

(51) Int. Cl. A23L 1/10; A23L 1/302; A23L 1/304; C11B 5/00; A23L 1/182; A23L 1/30; A23L 1/305

(52) U.S. Cl. 426/72; 426/74; 426/541; 426/627; 426/648; 426/452

(57) ABSTRACT

The present invention is directed to isolating the valuable components of cereal grains and allowing the benefits to be more fully exploited. The concept of the present invention initially involves selection of cultivars of cereal grains such as wheat, barley, oats and rye having desired bioactive components including antioxidants, complex phenolics, lignans, flavonoids, vitamins, fiber, protein and other nutrients concentrated in one or more of the outer bran layers. Then separating the outer bran layer into three fractions, according to the desired bioactive components contained in the bran layers including antioxidants, complex phenolics, lignans, flavonoids, vitamins, fiber, protein and other nutrients. This allows the maximum benefit and value to be obtained from the bran fractions as dietary supplements, nutraceuticals, or as enriched food products.

### FIELD OF THE INVENTION

The present invention relates to nutraceutical fractions from cereal grains such as wheat, barley, oats or rye. In particular the present invention relates to flour and bran fractions for use as a nutraceutical source in food products and a process for their production.

### BACKGROUND OF THE INVENTION

Cereal grains such as wheat, barley, oats and rye generally consist of an outer bran layer that encases the endosperm and germ. Conventional cereal grain milling involves removal of some or all of the outer bran layer, separation of the germ and then grinding the endosperm. Cereal grain milling typically involves a series of steps: cleaning, tempering, grinding, sifting and purifying. The general objective of the milling process is to extract from the grain the maximum amount of endosperm in the purest form. The endosperm is either ground into flour or semolina. This requires the efficient separation of the components of the grain, namely the bran, endosperm, and germ. Bran and germ typically are considered to have a detrimental effect on the end milled products.

In the conventional wheat milling process for example, after the initial cleaning steps, the wheat kernels are conditioned with water and/or steam and allowed to rest in temper bins for 4 to 20 hours (tempering) to toughen the bran coats of the wheat kernels and soften or mellow the endosperm. Tempering of the wheat kernels fuses the bran coats together and is an essential conditioning step of the kernels carried out prior to the conventional milling process to alter the physical state of the kernels in a desired manner. Tempering is undoubtedly the most important factor in determining the amount of endosperm produced from given wheat kernels and, therefore, great care is taken to appropriately condition the kernels prior to milling. The tempering of the wheat kernels to toughen and fuse the bran coats, unfortunately, also causes some fusion of the endosperm to the inner layers of bran whereby separation of these components is more difficult. The conditioned kernels are then subjected to successive stages, each of which grind, separate and purify the product. The first grinding operation (first break) opens the tempered kernels to expose the endosperm and scrape a portion of the endosperm from the bran. The coarsely ground mixture of bran, germ and endosperm particles is then sifted to classify the particles for further grinding, purification or sifting. The finer classified particles, which are a mixture of endosperm, bran and germ are then sent to the appropriate purification steps. The coarse remainder, consisting of bran and adhering endosperm, is sent to the next grinding step (second break) to remove more of the endosperm from the bran. The process of grinding, sifting and purification is repeated up to five or six times (5 or 6 breaks) in a conventional mill. However, each grinding process produces fine bran particles (bran powder) and germ particles which have a tendency to be separated with the endosperm and are difficult if not impossible, to remove from the endosperm. Each grinding operation produces more and more bran powder, compounding the problem.

In cereal grain milling the removed bran is commonly used for animal feed or human consumption as whole bran. In wheat processing, for example, the removed bran is used primarily for animal feed or as whole bran and the endosperm ground into flour for baking or pasta production. Barley is used primarily for animal feed, to produce malt for beer production, for seed and to a lesser extent as an ingredient in human food applications. Separation of the milled grain into different fractions is typically merely separation of the ground endosperm and adhering bran based on density or particle size of the products produced at each grinding step.

Cereal grains such as wheat, oats, barley and rye are known to be rich sources of bioactive components including antioxidants, complex phenolics, lignans, flavonoids, vitamins, fiber, protein and other nutrients. Most efforts to isolate the various bioactive components involves milling the cereal grain by grinding then extracting from the flour or bran, using chemical methods, the desired bioactive components.

A great deal of study is currently being done on “functional foods”. Functional foods are foods and food components that provide a health benefit beyond basic nutrition. Functional foods provide essential nutrients beyond quantities necessary for normal maintenance, growth and development and/or provide biologically active components that impart health benefits or desirable physiological effects.

There is a need for an efficient and effective method for separation of cereal grains into fractions according to the bioactive components contained therein.

### SUMMARY OF THE INVENTION

The present invention is directed to isolating the valuable components of cereal grains and allowing the benefits to be more fully exploited. The concept of the present invention initially involves selection of cultivars of cereal grains such as wheat, barley, oats and rye having desired bioactive components including antioxidants, complex phenolics, lignans, flavonoids, vitamins, fiber, protein and other nutrients concentrated in one or more of the outer bran layers. Then separating the outer bran layer into preferably three fractions, according to the desired bioactive components contained in the bran layers including antioxidants, complex phenolics, lignans, flavonoids, vitamins, fiber, protein and other nutrients. This allows the maximum benefit and value to be obtained from the bran fractions as dietary supplements, nutraceuticals, or as enriched food products. The endosperm may be further processed into flour or a starch source for example in ethanol production. The fractionation process produces three types of bran fractions, arbitrarily labeled “A,” “B,” and “C”. Each of the bran fractions has different functions and applications. For example from the food processor's perspective, it is much easier to increase fiber by adding a high fiber bran fraction as an ingredient, providing that a source of high purity bran is routinely available. The products of the present invention can be used in the formulation of nutritional products such as energy bars or in the case of the high protein fractions for aquaculture.

Accordingly one aspect of the present invention provides a process for the separation of cereal grains having an endosperm and germ encased in an outer bran, wherein the outer bran comprises a series of separate layers having different chemical and physical properties, into different fractions having desired bioactive components, the process comprising:

(a) selecting one or more cultivars of a clean, dry cereal grain selected from the group consisting of wheat, barley, oats and rye, said cultivars having desired bioactive components selected from the group consisting of antioxidants, complex phenolics, lignans, flavonoids, vitamins, minerals, fiber, protein and other nutrients in one or more of the layers of the outer bran in concentrations suitable for use as a nutraceutical;
(b) conditioning a selected dry clean cultivar with about 1-3% by weight of water;
(c) then after the moisture has penetrated only through fibrous layers of the outer bran without fusing the layers of the outer bran together, feeding the conditioned cultivar to one or more machines where the grains of the conditioned cultivar are rubbed vigorously together to remove the fibrous layers of the outer bran down to a seed coat layer, wherein the removed fibrous layers are high in soluble and insoluble fiber;
(d) separating and collecting the removed fibrous layers from the processed cultivar by air aspiration and the removed fibrous layers are dried and screened;
(e) then feeding the conditioned cultivar with the fibrous layers of the outer bran removed, to one or more machines where the grains of the conditioned cultivar are rubbed against abrasion stones to remove the remaining inner layers of the adhering outer bran;
(f) separating and collecting the removed inner layers from the processed cultivar by air aspiration into two bran fractions, a first bran fraction having a fiber content of less than 40% and a protein content of 20 to 25% and a second bran fraction having less than 20% fiber.

In another aspect the present invention provides a high fiber composition comprising the epidermis, hypodermis, cross-cell and tube cell layers of the bran layers of a cultivar, preferably a barley cultivar, having desired bioactive components selected from the group consisting of antioxidants, complex phenolics, lignans, flavonoids, vitamins, minerals, fiber, protein and other nutrients in one or more of the layers of the outer bran in concentrations suitable for use as a nutraceutical. The barley cultivar is preferably selected from the group consisting of CDC Fibar a two-row waxy hull-less variety of barley, CDC Alamo a two-row waxy hull-less barley, Merlin a waxy two-rowed hull-less barley, Waxbar a two-rowed hulled barley, WB Salute a two-row hulled, waxy, high beta glucan barley, and CDC McGwire a two-row hull-less barley. The high fiber composition has a soluble and insoluble fiber content greater than 75% by weight and protein content of less than 18% by weight.

In a still further aspect of the invention a composition is provided comprising the inner bran layers of a cultivar, preferably a barley cultivar, having desired bioactive components selected from the group consisting of antioxidants, complex phenolics, lignans, flavonoids, vitamins, minerals, fiber, protein and other nutrients in one or more of the layers of the outer bran in concentrations suitable for use as a nutraceutical. A preferred medium protein composition comprises one or more inner bran layers of a barley cultivar said composition consisting mainly of the seed coat (testa), nucellar tissue, and some aleurone cells and having a soluble and insoluble fiber content less than 40% by weight and protein content of less than 25% by weight. Another preferred low fiber composition comprises one or more inner bran layers of a barley cultivar mainly consisting of the aleurone cell layer and may also contain a portion of the seed coat and nucellar tissue, said composition is high in soluble beta glucan from the aleurone cell layer and having a soluble and insoluble fiber content less than 20% by weight and protein content of less than 18-20% by weight and with a good hypoglycemic index.

In yet another aspect the present invention provides a bar formulation having as a major active ingredient up to 50% by weight of one or more the bran fraction compositions noted above derived from a barley cultivar, 0-10% of lipid supplement, up to 50% of a carbohydrate supplement, up to 25% of a complex carbohydrate supplement and 0 to 25% of a protein supplement. In a preferred formulation having high soluble and insoluble fiber for reduction of serum cholesterol and low glycemic index nutrition, the bar comprises up to 50% of a high fiber composition derived from a barley cultivar as the major active ingredient of the present invention, 5 to 10% of a lipid supplement, up to 50% of a carbohydrate supplement and up to 25% of a complex carbohydrate supplement. The complex carbohydrate supplement in this formulation is one or more wheat bran fractions produced by the process of the present invention. Another preferred formulation having high protein and high soluble fiber and used as an immune system booster and performance enhancer comprises up to 50% of a barley bran fraction composition of the present invention as the major active ingredient, up to 50% of a carbohydrate supplement, up to 25% of a complex carbohydrate supplement and up to 25% of a protein supplement. Another preferred formulation has balanced protein and is used as a meal replacement product with an immune system booster comprises as the major active ingredients up to 25% of a medium protein barley bran composition of the present invention and up to 50% of the low fiber barley bran composition of the present invention, up to 25% of a carbohydrate supplement, up to 25% of a complex carbohydrate supplement and up to 10% of a protein supplement.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a schematic representation of the barley grain structure.

FIG. 2 is a schematic representation of the outer bran layers of barley.

FIG. 3 is a schematic representation of the wheat grain structure.

FIG. 4 is a schematic drawing of the process for fractionation of barley and wheat to produce bran fractions containing desired bioactive components and the application of the bran fractions according to the present process

FIG. 5 is a schematic drawing of the debranning process for fractionation of a cereal grain included in the process of FIG. 4.

FIG. 6 is a chart of different possible bar formulations incorporating the products of the present invention.

### DETAILED DESCRIPTION OF THE PREFERRED EMBODIMENTS

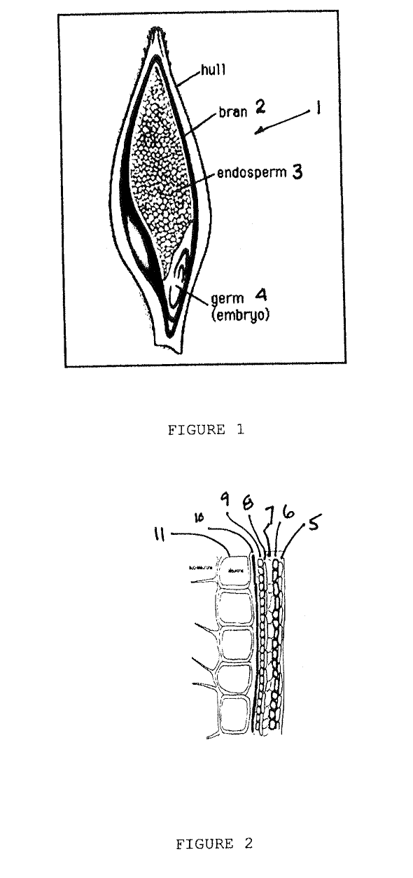

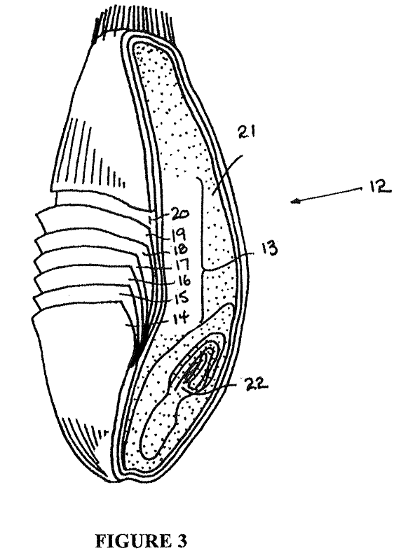

The outer bran layer of cereal grains is composed of different cell layers having different chemical and physical properties. The barley grain 1, for example, is shown schematically in FIG. 1. Barley can be either of a conventional variety that has a husk or hull enclosing the barley grain or a hull-less variety. In either case the barley grain 1 has an outer bran layer 2 encasing the endosperm 3 and germ 4. The outer bran layer of barley as shown schematically in FIG. 2 has seven different layers: the epidermis 5, hypodermis 6, cross cells 7, tube cells 8, seed coat 9, nucellar tissue 10 and aleurone cells 11. Barley has been shown to have many valuable health and nutritional characteristics, including promoting the health and improved function of the digestive system and the immune system. USDA clinical trials have shown that the consumption of barley containing beta glucan significantly improved several cardiovascular risk factors in high cholesterol men, reducing cholesterol about 5% to 10% when consumed with a healthy diet. Systolic, diastolic and mean arterial blood pressure was significantly reduced by whole grain diets regardless of the fiber source. The present invention is directed to producing products in which these valuable components are present in concentrations sufficient to provide a nutraceutical effect and thereby allowing the benefits to be fully more exploited.

There are two types of fiber found in the layers of bran in barley. Soluble fiber, such as beta glucan is not only found in the bran, but is also present throughout the barley kernel. Soluble fiber dissolves in water and turns into a thick gel as it passes through the digestive system. The gel-like substance coats the wall of the digestive system, slowing digestion and the absorption of nutrients. Soluble fiber is thought to help lower blood cholesterol and modulate blood sugar levels. Insoluble fibers include: cellulose, some hemicelluloses, lignin, and enzyme-resistant starches. Insoluble fiber does not dissolve in water, but absorbs water as it moves through the intestine. This type of fiber promotes bowel regularity, manages intestinal disorders, and is thought to be beneficial in preventing colon cancer.

The wheat kernel 12, generally shown in FIG. 3, has a bran coat 13 made up of several different layers identified as 14 through 20. The layers of bran from the outer to inner layer are: epidermis 20, hypodermis 19, cross cells 18, tube cells 17, seed coat 16, nucellar tissue (hyaline layer) 15 and aleurone cells 14. Interior to the bran coat is the endosperm 21 with the wheat germ generally identified as 22. In general, the bran layers collectively make up about 15% by weight of the wheat kernel, whereas the germ represents about 2.5% and the endosperm represents about 83% by weight of the wheat kernel.

The concept of the present invention is to separate the outer bran layers, for example 5 thru 11 in FIG. 2 and 14 thru 20 in FIG. 3, of the cereal grain, in this case barley or wheat into different fractions based on the bioactive components contained therein. This allows the maximum benefit and value to be achieved from the fractions whether used as dietary supplements, nutraceuticals or as ingredients in enriched food products. In the embodiment illustrated herein, the fractionation process of the present invention preferably produces three types of bran fractions, arbitrarily labeled “A,” “B,” and “C”. Each of the bran fractions has different functions and applications. From the food processor's perspective, it is much easier to increase fiber by adding a bran fraction having high fiber content as an ingredient.

The process of the present invention is a unique system that progressively removes the exterior layers from any cereal grain. Barley, for example, has seven distinct layers of cells that each has different characteristics. The process of the present invention gradually removes these layers so that the separate cell layers can be collected to produce bran fractions that vary in fiber, protein, nutrients, vitamins and trace mineral content.

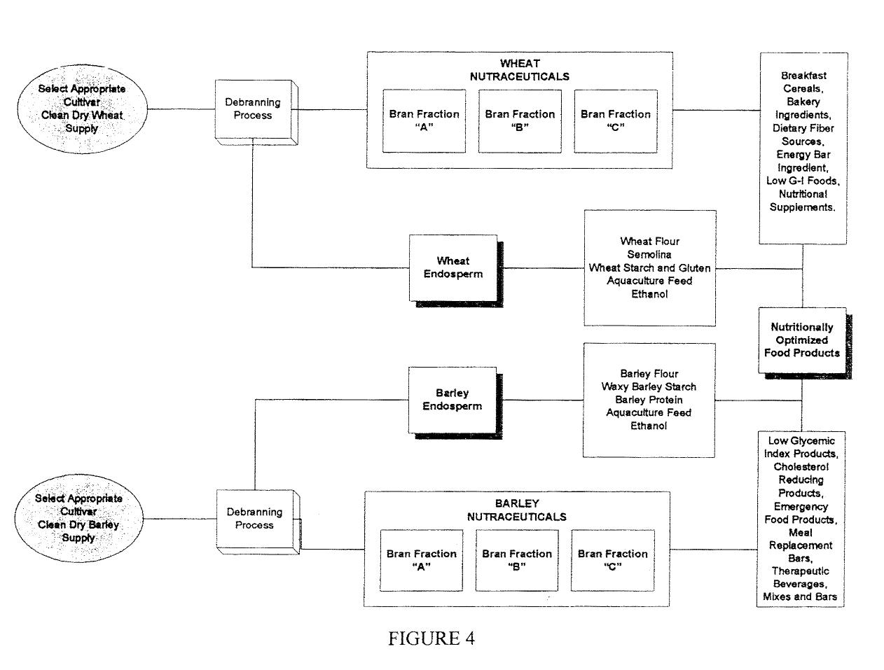

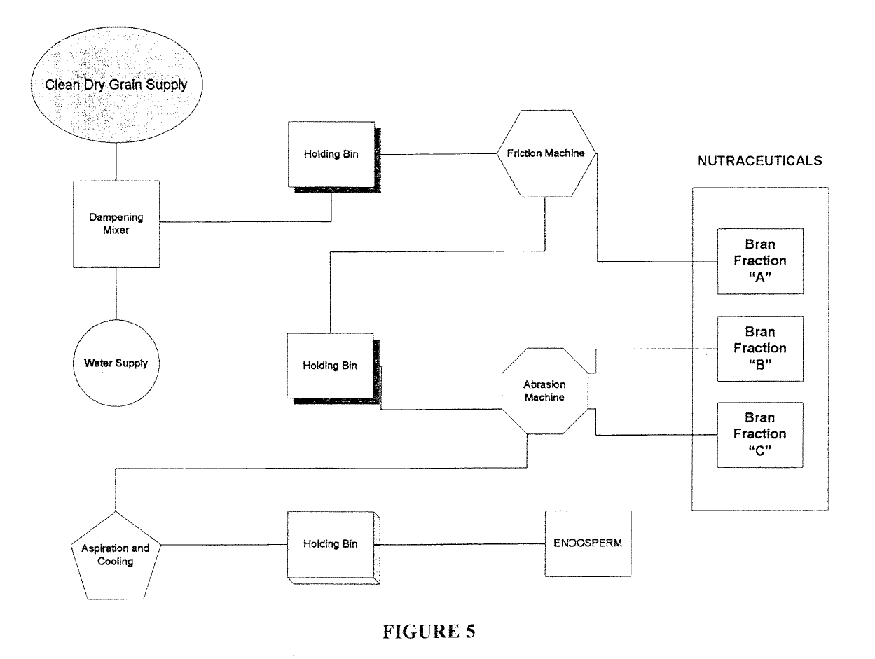

The present invention as noted above is directed to a process for the separation of cereal grains selected from the group consisting of barley, oats, wheat and rye having an endosperm and germ encased in an outer bran, wherein the outer bran comprises a series of separate layers having different chemical and physical properties, into different fractions having desired bioactive components. As best illustrated in FIGS. 4 and 5 in connection with barley and wheat, as a first step the process comprises selecting one or more cultivars of a clean, dry cereal grain selected from the group consisting of wheat, barley, oats and rye. The selected cultivars have desired bioactive components selected from the group consisting of antioxidants, vitamins, minerals, complex phenolics, lignans, flavonoids, fiber, protein and other nutrients concentrated in one or more of the layers of the outer bran. The present invention preferably selects a cultivar of barley, wheat or oats with high beta glucan content in bran as opposed to in the endosperm. Conventional barley breeding (90% of barley cultivated in North America is used for malting) to date has been focused on improved varieties for malting in which the objective is to reduce the beta-glucan levels. The present invention is directed to identifying varieties that have high beta-glucan levels. Varieties identified to date as useful in the present invention are CDC Fibar a two-row waxy hulless variety of barley, CDC Alamo a two-row waxy hulless barley, Merlin a waxy two-rowed hulless barley, Waxbar a two-rowed hulled barley, WB Salute a two-row hulled, waxy, high beta glucan barley, and CDC McGwire a two-row hull-less barley. Useful wheat varieties that have high beta-glucan levels include two waxy wheat varities currently identified as ID-629 and ID-630.

Beta glucans are soluble fiber compounds found in barley, oats, and yeast cells with negligible amounts normally found in other cereal grains such as wheat and rye. In the case of some grains such as barley, beta glucan is found not only in the bran layers, but also in the meal produced from grinding whole or pearled grain. The barley kernel generally contains beta glucan in the 4 to 5% range, although some cultivars may contain higher percentages. Depending on the cultivar, the beta glucan may be dispersed evenly throughout the endosperm or may have high concentrations in the bran layers particularly the aleurone layer. It has been reported that experimental varieties are being developed to concentrate beta-glucans in the bran layers. It is also expected that cultivars having high beta-glucan levels will have high concentrations in the bran layers.

Beta glucans are reported to promote health and improve the function of the digestive and immune systems. Beta glucans can absorb many times their weight of water, forming a thick indigestible gel. As the gel passes through the digestive system it coats the lining of the gastrointestinal tract, slowing digestion and the absorption of nutrients. They are also reported to reduce the risk of heart disease by lowering serum cholesterol levels. Beta glucans modulate the rate at which sugar is absorbed and released into the blood stream. In addition, they have antioxidant properties that help to control the levels of free radicals (highly reactive compounds that can damage DNA or cell membranes) in the intestine, and it is speculated that this property accounts in part for the protective effects of beta glucans on colon cancer. These health claims do not have FDA approval for use on labels; however through the efforts of the US National Barley Foods Council and others, an application for approval has been submitted to the FDA. The review process has now been completed and the US FDA has authorized use of a health claim for the role of beta-glucan soluble fiber from barley in reducing the risk of coronary heart disease.

Presently oats and oat products have FDA approval for health-claim labeling in the United States, and it is generally accepted that these products possess the beneficial qualities associated with dietary fiber, including those associated with beta glucans. The primary source of beta glucans in food has been oats, yeast cell walls, and mushrooms. However, there are varieties of hulless waxy barley that have higher levels of beta glucans than are found in oats. Until recently, it has been difficult to isolate barley beta glucan in a high enough purity for it to be used as a food ingredient.

The phenolic compounds in the wheat bran fractions, including phenolic acids, lignans and flavonoids, have been reported, together with dietary fiber, to protect against cancer, diabetes and coronary disease. Suitable wheat cultivars identified to date whose bran layers have nutraceutical properties include all current Canadian Red Spring wheats and Durum wheats and preferably two waxy wheat varieties currently identified as ID-629 and ID-630. The bran layers that are removed and separated have significant quantities of insoluble fiber and of flavinoids. Protein quality is nutritionally superior in the bran layers compared with the gluten of the wheat endosperm.

In order for the outer bran layers to be removed and collected according to their bioactive components the process, as shown in FIG. 4, continues after selection of the desired cultivar by subjecting the wheat and barley cultivars to a debranning process. A process for debranning wheat is described for example in U.S. Pat. No. 5,082,680; U.S. Pat. No. 5,240,733 and U.S. Pat. No. 5,387,430 which are hereby incorporated by reference. It has been determined by the present inventors that a similar process for debranning barley can be utilized. The debranning process progressively removes the outer bran layers of the barley or wheat kernel enabling the removal, separation and collection of desired bran layers as opposed to a single substantially homogeneous bran product as in conventional milling or pearling operations. In FIG. 4 the outer bran layers removed during the debranning process are separated into three preferred fractions. One or more of the wheat bran fractions have utility in for example breakfast cereals, bakery ingredients, dietary fiber sources, energy bar ingredients, low glycemic index foods and nutritional supplements. The wheat endosperm can be milled into flour or semolina, separated into starch or gluten or used in aquaculture or in ethanol production. One or more of the barley bran fractions have utility in for example low glycemic index products, cholesterol reducing products, emergency food products, meal replacement bars and therapeutic beverages, mixes or bars. The barley endosperm can be milled into flour, separated into starch or protein or used in aquaculture or in ethanol production.

The debranning process is schematically illustrated in FIG. 5 and starts by conditioning a selected clean dry cultivar with about 1-3% by weight of water in a dampening mixer. The dampened grain is fed to a holding bin and within a few minutes, preferably within about five minutes, after the moisture has penetrated only through fibrous layers of the outer bran without fusing the layers of the outer bran together, the conditioned cultivar is fed to one or more “friction” type machines where the grains of the conditioned cultivar are rubbed vigorously together to remove the fibrous layers of the outer bran down to the seed coat layer. The removed fibrous layers are separated and collected from the processed cultivar by air aspiration and the removed fibrous layers are dried and screened. The removed fibrous layers are arbitrarily designated fraction A. The bran fraction “A” is a combination of the outer bran layers of the barley or wheat kernel. The outer layers consist mainly of the epidermis, hypodermis, cross-cell and tube cell layers. The A fraction has a high fiber (˜78%), and low protein (˜8%) content. This product comprises approximately 3.5% of a hulless barley or wheat kernel by weight. The bran fraction “A” in barley can be utilized in breakfast cereals, breads and baked goods, breading and batters, snacks, fiber supplements, and meal replacement beverages. The processed grain with the outer fibrous layers removed exits the “friction” type machine to a second holding bin. Preferred “friction” type machines are available from Prokop Milling Machines in the Czech Republic but rice whitening machines (both horizontal and vertical machines) are available and can be modified to do the job.

The conditioned cultivar with the fibrous layers of the outer bran removed, is then fed to one or more “abrasion” type machines where the grains of the conditioned cultivar are rubbed against abrasion stones to remove the remaining inner layers of the adhering outer bran. The removed inner bran layers are separated and collected by air aspiration into two bran fractions, a first bran fraction, designated fraction B, typically having a fiber content of 40% and a protein content of 22 to 25% and a second bran fraction, designated fraction C, high in soluble beta glucan from an aleurone layer in the case of barley, low in protein and with a good hypoglycemic index.

The bran fraction “B” consists mainly of the seed coat (testa), nucellar tissue, and some aleurone cells. The product is so named because of the moderate fiber content less than 40%, and relatively high protein content (25 to 22%). The product comprises approximately 2.5% of a hulless barley or wheat kernel by weight. Bran fraction “B” can be utilized in breakfast cereals, baked goods, batters and breadings, sauces, and grain-based beverages.

The bran fraction “C” is mainly comprised of the aleurone cell layer that surrounds the endosperm of the hulless barley or wheat kernel. It may also contain a portion of the seed coat and nucellar tissue. The C fraction has a relatively low fiber content less than 20% and relatively high protein content 18-20%. The C fraction represents approximately 4% of the hulless barley or wheat kernel by weight. The bran fraction “C” will find uses in enrichment of flour, grain-based beverages, breakfast cereals, soup and sauce thickeners, and supplements. The percentage of inclusion in the above products will vary according to the desired result or proprietary recipe of each food manufacturer.

The process is completed by milling the cultivar with the layers of the outer bran removed to produce a product suitable for a use selected from the group consisting of fermentation to produce ethanol, preparation of an aquaculture feed and for use as an ingredient in food products.

Barley flour, for example, consists of a mixture of starch, protein, and beta glucan, with other remaining non-solubles and ash making up the remainder. The protein content for the waxy hulless barley cultivars is generally in the 12.5 to 15% range. Varieties with high protein in the aleurone layer are ideal for dry fractionation that produces a high protein (25-30%) barley flour. This ingredient is ideal for addition to nutritional meal replacement formulas and other applications requiring higher protein.

As noted above a functional food is described as “food in which concentrations of one or more ingredients have been manipulated or added to enhance their contributions to a healthful diet.” In the past, functional foods were relegated to health food stores but recently they have moved into mainstream supermarkets and have become the fastest growing segment of the food industry.

All the bran fractions of the present invention will have a market in the functional food arena. As components, these products can be mixed and matched with traditional ingredients to produce foods with beneficial health benefits.

The “C” fraction of bran is an excellent example of such an ingredient. This fraction in the case of barley has both soluble (beta-glucan) and insoluble (cellulose) fiber. Beta glucans may reduce heart disease, diabetes, and some cancers. The insoluble fiber improves the function of the digestive tract, while both soluble and insoluble fiber support the immune system.

Nutraceuticals are defined as “food and beverages with an added ingredient that provides a medical benefit or helps to prevent disease.” In other words, a combination of “nutritional” and “pharmaceutical” that refers to foods that elicit responses similar to traditional medicines. The barley bran products produced from fractionation fit this category very well. The beta glucans, bran fibers, and possibly certain starches appear to have a place in this market.

In the 1970's, the Granola Bar was introduced as a nutritious alternative to the candy bar. The initial products were focused on organic and unrefined ingredients that conveyed a “natural” image, but tended to be highly variable and were poorly packaged and experienced short shelf life. As the main stream food companies moved to more “natural” style products that appealed to healthy eating for consumers, new product introductions were made that improved the quality of the granola bar. In the 1990's the bar market diversified into the areas of meal replacement, reduced calorie, and high-protein products for body building or nutritional supplement. The bars have become a delivery vehicle for a full range of nutrients.

Bar products using the bran fractions of the present invention may be created to delivery specific nutritional benefits. As noted, products made primarily from the Fraction “A” will be an excellent source of dietary fiber. It will have, in the case of barley, levels (greater than 75%) of soluble fiber from the beta glucans and insoluble fiber from the outer layers that will be sufficient to help reduce serum cholesterol (low density lipoproteins) by up to 12% on a daily consumption of a single 100 gram bar. The barley bran “B” Fraction provides high protein (20-25%) and good levels of fiber (less than 40%). A bar based on the “B” Fraction would help modulate blood glucose levels for diabetics. The “C” Fraction would be high in protein (18-20%) and lower in fiber (less than 20%). This would be an excellent ingredient in meal replacement products. It could also be used for a nutritional supplement for young people and athletes. In addition, with a full complement of vitamins and minerals, these bars could serve as an emergency food source for disaster relief or for humanitarian food aid.

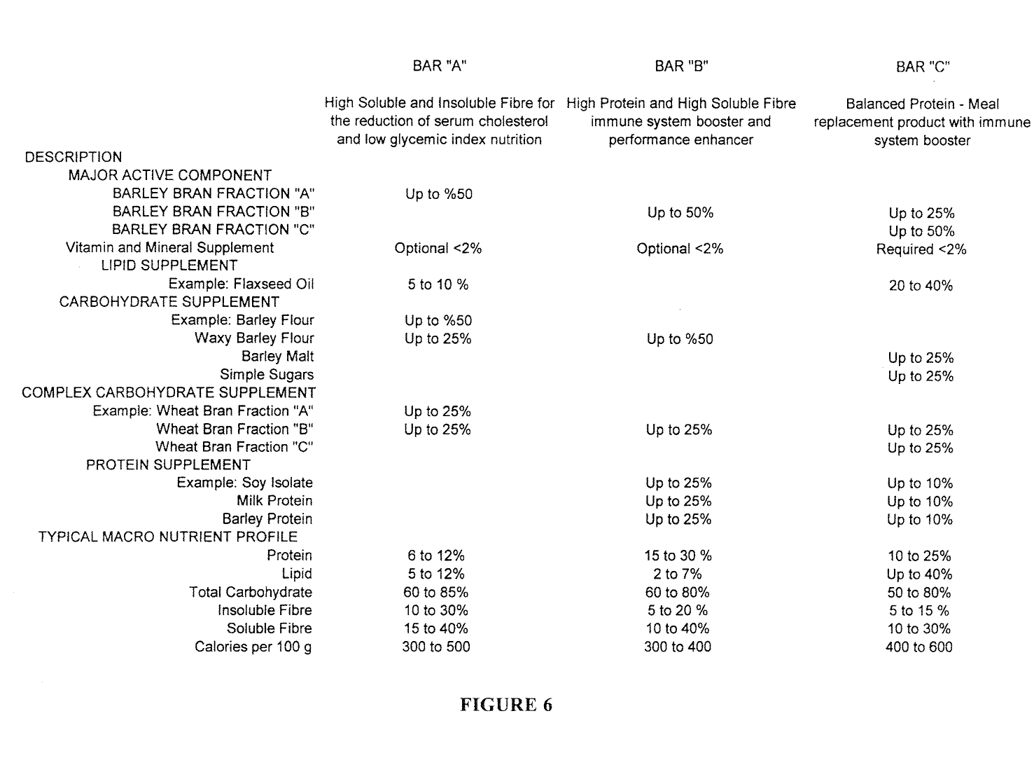

FIG. 6 provides a chart identifying three different bar products and the possible formulations using the bran fractions of the present invention together with other products. In each case the formulation includes a major bioactive component contained with in one or more of the barley bran fractions of the present invention. The bar formulations also include as a complex carbohydrate supplement one or more of the wheat bran fractions. Other components include a vitamin and mineral supplement (optional), a lipid supplement, a carbohydrate supplement and a protein supplement. These bar formulations have been created for specific nutraceutical effects as noted in FIG. 6. Where other effects are desired different formulations are possible using the bran fractions of the present invention as major ingredients.

The bran fractions that are produced by the present invention have a value as human food that is generally 5 to 6 times that of feed material. Total yields of the three fractions are about 10% of the clean barley or wheat weight.

Although various preferred embodiments of the present invention have been described herein in detail, it will be appreciated by those skilled in the art that variations may be made thereto without departing from the spirit of the invention or the scope of the appended claims.

1. A process for the separation of cereal grains having an endosperm and germ encased in an outer bran, wherein the outer bran comprises a series of separate layers having different chemical and physical properties, into different fractions having desired bioactive components, the process comprising:
(a) selecting one or more cultivars of a clean, dry cereal grain selected from the group consisting of wheat, barley, oats and rye, said cultivars having desired bioactive components selected from the group consisting of antioxidants, complex phenolics, lignans, flavonoids, vitamins, minerals, fiber, protein and other nutrients in one or more of the layers of the outer bran in concentrations suitable for use as a nutraceutical;
(b) conditioning a selected dry clean cultivar with about 1-3% by weight of water;
(c) then after the moisture has penetrated only through fibrous layers of the outer bran without fusing the layers of the outer bran together, feeding the conditioned cultivar to one or more machines where the grains of the conditioned cultivar are rubbed vigorously together to remove the fibrous layers of the outer bran down to a seed coat layer, wherein the removed fibrous layers are high in soluble and insoluble fiber;
(d) separating and collecting the removed fibrous layers from the processed cultivar by air aspiration and the removed fibrous layers are dried and screened;
(e) then feeding the conditioned cultivar with the fibrous layers of the outer bran removed, to one or more machines where the grains of the conditioned cultivar are rubbed against abrasion stones to remove the remaining inner layers of the adhering outer bran;
(f) separating and collecting the removed inner layers from the processed cultivar by air aspiration into two bran fractions, a first bran fraction having a fiber content of less than 40% and a protein content of 20 to 25% and a second bran fraction having less than 20% fiber.

2. A process according to claim 1 including the step of processing the cultivar with the layers of the outer bran removed to produce a high protein low fiber flour suitable for a use selected from the group consisting of fermentation to produce ethanol, preparation of an aquaculture feed and use as an ingredient in food products.

3. A process according to claim 1 or 2 wherein the cereal grain is barley.

4. A process according to claim 3 wherein the barley cultivar has a beta glucan content of 15 to 30% in the fibrous layers of the outer bran.

5. A process according to claim 3 or 4 wherein the barley cultivar is selected from the group consisting of CDC Fibar a two-row waxy hull-less variety of barley, CDC Alamo a two-row waxy hull-less barley, Merlin a waxy two-rowed hull-less barley, Waxbar a two-rowed hulled barley, WB Salute a two-row hulled, waxy, high beta glucan barley, and CDC McGwire a two-row hull-less barley.

6. A process according to claim 1 or 2 wherein the cereal grain is wheat.

7. A process according to claim 6 wherein the wheat cultivar is selected from the group consisting of Canadian Red Spring wheats, a waxy wheat variety identified as ID-629, a waxy wheat variety identified ID-630 and Durum wheats wherein the bran layers that are removed and separated have significant quantities of insoluble fiber and of flavinoids.

8. A process according to claim 7 wherein the protein quality of the removed bran layers is nutritionally superior to the gluten of the wheat endosperm.

9. A high fiber composition produced by the process of any one of claims 1 to 5 comprising the epidermis, hypodermis, cross-cell and tube cell layers of the bran layers of a cultivar having desired bioactive components selected from the group consisting of antioxidants, complex phenolics, lignans, flavonoids, vitamins, minerals, fiber, protein and other nutrients in one or more of the layers of the outer bran in concentrations suitable for use as a nutraceutical.

10. A high fiber composition according to claim 9 comprising one or more outer bran layers of a barley cultivar and having a soluble and insoluble fiber content greater than 75% by weight and protein content of less than 18% by weight.

11. A high fiber composition according to claim 10 wherein the barley cultivar is selected from the group consisting of CDC Fibar a two-row waxy hull-less variety of barley, CDC Alamo a two-row waxy hull-less barley, Merlin a waxy two-rowed hull-less barley, Waxbar a two-rowed hulled barley, WB Salute a two-row hulled, waxy, high beta glucan barley, and CDC McGwire a two-row hull-less barley.

12. A composition produced by the process of any one of claims 1 to 5 comprising the inner bran layers of a cultivar having desired bioactive components selected from the group consisting of antioxidants, complex phenolics, lignans, flavonoids, vitamins, minerals, fiber, protein and other nutrients in one or more of the layers of the outer bran in concentrations suitable for use as a nutraceutical.

13. A composition according to claim 12 comprising one or more inner bran layers of a barley cultivar said composition consisting mainly of the seed coat (testa), nucellar tissue, and some aleurone cells and having a soluble and insoluble fiber content less than 40% by weight and protein content of less than 25% by weight.

14. A composition according to claim 12 comprising one or more inner bran layers of a barley cultivar mainly consisting of the aleurone cell layer and may also contain a portion of the seed coat and nucellar tissue, said composition high in soluble beta glucan from the aleurone cell layer and having a soluble and insoluble fiber content less than 20% by weight and protein content of less than 18-20% by weight and with a good hypoglycemic index.

15. A meal replacement bar having as a major active ingredient up to 50% by weight of one or more compositions selected from a composition according to any one of claims 9 to 14, 0-10% of lipid supplement, up to 50% of a carbohydrate supplement, up to 25% of a complex carbohydrate supplement and 0 to 25% of a protein supplement.

16. A meal replacement bar according to claim 15 having high soluble and insoluble fiber for reduction of serum cholesterol and low glycemic index nutrition comprising up to 50% of a high fiber composition according to claims 10 or 11 as the major active ingredient, 5 to 10% of a lipid supplement, up to 50% of a carbohydrate supplement and up to 25% of a complex carbohydrate supplement.

17. A meal replacement bar according to claim 16 wherein the complex carbohydrate supplement is one or more wheat bran fraction produced by the process of claims 6 to 9.

18. A meal replacement bar according to claim 15 having high protein and high soluble fiber and used as an immune system booster and performance enhancer comprising up to 50% of the composition according to claim 12 or 13 as the major active ingredient, up to 50% of a carbohydrate supplement, up to 25% of a complex carbohydrate supplement and up to 25% of a protein supplement.

19. A meal replacement bar according to claim 18 wherein the complex carbohydrate supplement is one or more wheat bran fraction produced by the process of claims 6 to 9.

20. A meal replacement bar according to claim 15 having balanced protein and used as a meal replacement product with an immune system booster comprising as the major active ingredients up to 25% of the composition according to claim 12 or 13 and up to 50% of the composition according to claim 12 or 14, up to 25% of a carbohydrate supplement, up to 25% of a complex carbohydrate supplement and up to 10% of a protein supplement.

21. A meal replacement bar according to claim 20 wherein the complex carbohydrate supplement is one or more wheat bran fractions produced by the process of claims 6 to 8.
